(19) United States
(12) Patent Application Publication
(10) Pub. No.: US 2002/0011837 A1
(43) Pub. Date: Jan. 31, 2002

(54) Rotation angle sensor

(75) Inventor: Takashi Sato, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 09/901,027

(22) Filed: Jul. 10, 2001

(30) Foreign Application Priority Data
Jul. 11, 2000 (JP) P 2000-210010

(51) Int. Cl. G01B 7/14

(52) U.S. Cl. 324/207.2; 324/207.25

(57) ABSTRACT

A rotation angle sensor 1 of the present invention for measuring a rotation angle of an object to be measured, comprises a rotation shaft 3 which is rotated by rotation of the object to be measured, a parallel magnetic field generator 5 for generating parallel magnetic field 43 which is rotated as the rotation shaft 3 rotates, magnetic force detector 6 for detecting magnetic field strength in the parallel magnetic field 43 generated by the parallel magnetic field generator 5, and for outputting output voltage based on the magnetic field strength, and rotation angle calculator 7 for calculating a rotation angle of the object to be measured based on the output voltage output from the magnetic force detector 6.

### BACKGROUND OF THE INVENTION

1. Field of the Invention

The present invention relates to a rotation angle sensor for magnetically detecting a rotation angle of an object to be measured, and more particularly, to a rotation angle sensor for measuring the rotation angle of the object to be measured by parallel magnetic field which rotates as a rotation shaft rotates.

2. Description of the Related Art

As a conventional rotation angle sensor, there is a magnetic position sensor using a Hall element as disclosed in Japanese Patent Application Laid-open No. H8-35809 for example. As shown in FIG. 1, the conventional magnetic position sensor comprises a tube-like yoke 112 integrally disposed on a driving shaft 111. A permanent magnet 115 is bonded to an inner side of a tube-like portion 113 of the tube-like yoke 112, and stators 116 and 117 in which a Hall element 119 is accommodated is disposed on an inner side of the permanent magnet 115.

This magnetic position sensor is constituted such that magnetic field strength which is proportional to the rotation angle is output, and the magnetic field strength is detected by the Hall element to obtain voltage output which is proportional to the rotation angle.

However, according to the conventional magnetic position sensor, the stators and tube-like yoke are necessary in addition to the permanent magnet, and there is a problem that its shape is complicated, the number of parts is great and thus, the cost of the sensor becomes high. Further, if the mounting precision of the various parts such as the stators is not high, there is a problem that the magnetic field strength which is proportional to the rotation angle can not be output.

Further, when the magnetic fields of the stators 116 and 117 are not symmetric with each other, i.e., when the magnetic pole boundary of the permanent magnet 115 is deviated from the center lines of the stators 116 and 117, magnetic fields in the stators 116 and 117 tend to be symmetric with each other. Thus, there is a problem that rotation torque is generated. For this reason, if the conventional magnetic position sensor is mounted to a rotation apparatus having small driving torque, there is an adverse possibility that the rotation apparatus does not rotate.

Further, in the conventional magnetic position sensor, the stators 116 and 117 which are magnetic materials are disposed near the permanent magnet 115. Therefore, a great attraction force is generated between the permanent magnet 115 and the stators 116 and 117 by magnetic force. Therefore, there is a problem that if the permanent magnet 115 and the stators 116 and 117 are not fixed strongly, the permanent magnet 115 is attracted by either one of the stators 116 and 117, and a desired characteristic can not be obtained.

### SUMMARY OF THE INVENTION

The present invention has been achieved with a view of the above circumstances, and it is an object of the invention to provide a rotation angle sensor having the small number of parts and simple shape.

To achieve the above object, according to a first aspect of the present invention, there is provided a rotation angle sensor for measuring a rotation angle of an object to be measured, comprising a rotation shaft which is rotated by rotation of the object to be measured, a parallel magnetic field generator generating parallel magnetic field which is rotated as the rotation shaft rotates, magnetic force detector detecting magnetic field strength in the parallel magnetic field generated by the parallel magnetic field generator, and for outputting output voltage based on the magnetic field strength, and rotation angle calculator calculating a rotation angle of the object to be measured based on the output voltage output from the magnetic force detector.

According to the first aspect, the sensor can be simplified in shape, and the number of parts thereof can be decreased.

According to a second aspect of the invention, the number of the magnetic force detector is two or more, and the plurality of magnetic force detector is disposed at different angles with respect to the parallel magnetic field, the rotation angle calculator calculates a rotation angle of the object to be measured based on output voltage output respective magnetic force detector.

According to the second aspect, it is possible to decrease the number of parts of the sensor with simple shape, and to measure a rotation angle in a range of 0° to 360°.

According to a third aspect, there is provided a rotation angle sensor for measuring a rotation angle of an object to be measured, comprising a rotation shaft which is rotated by rotation of the object to be measured, a parallel magnetic field generator generating parallel magnetic field which is rotated as the rotation shaft rotates, magnetic force converter detecting magnetic field strength in the parallel magnetic field generated by the parallel magnetic field generator, and converting this magnetic field strength into output voltage indicative of a rotation angle of the object to be measured.

According to the third aspect, the sensor can be simplified in shape, and the number of parts thereof can be decreased.

According to a fourth aspect of the invention, the number of the magnetic force detector is two or more, and the plurality of magnetic force detector is disposed at different angles with respect to the parallel magnetic field, the rotation angle sensor further comprises rotation angle calculator calculating a rotation angle of the object to be measured based on output voltage output respective magnetic force detector.

According to the fourth aspect, it is possible to decrease the number of parts of the sensor with simple shape, and to measure a rotation angle in a range of 0° to 360°.

### BRIEF DESCRIPTIONS OF THE DRAWINGS

FIG. 1 shows a structure of a conventional magnetic position sensor;

FIG. 2A shows a structure of an embodiment of a rotation angle sensor of the predetermined;

FIG. 2B shows a structure of an embodiment of magnetic detector of the invention;

FIG. 3A is a perspective view showing one example of parallel magnetic field generator 5 shown in FIG. 2A;

FIG. 3B is a sectional view in FIG. 3A;

FIG. 4 shows one example of parallel magnetic field generator 5 shown in FIG. 2A;

FIG. 5 shows the principle of the rotation angle sensor of the present invention;

FIG. 6 is a view for explaining output characteristic of the rotation angle sensor according to a first embodiment;

FIG. 7A is a top view for explaining a layout of a Hall IC when a rotation angle of 0° to 360° is detected;

FIG. 7B is a side view for explaining the layout of the Hall IC when the rotation angle of 0° to 360° is detected;

FIG. 8 is a top view for explaining an output characteristic of the Hall IC when the rotation angle of 0° to 360° is detected;

FIG. 9 is a block diagram for explaining a structure of a non-linear Hall IC;

FIG. 10 is a graph for explaining an output characteristic of the non-linear Hall IC; and

FIG. 11 is a graph for explaining an output characteristic of a rotation angle sensor according to a second embodiment.

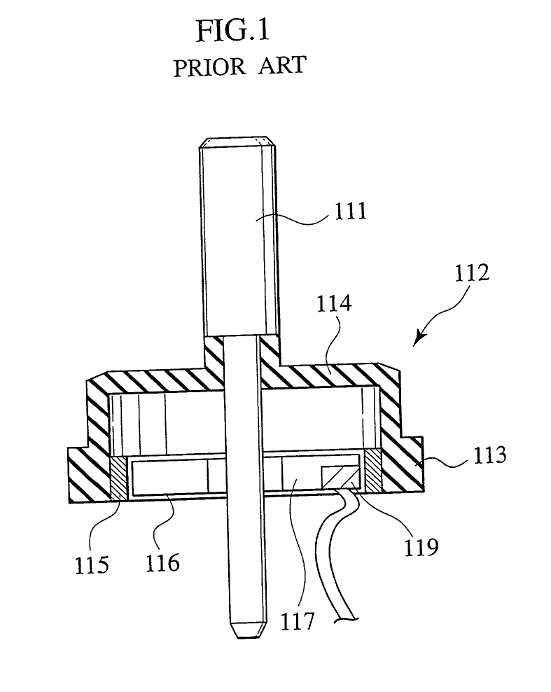

### DETAILED DESCRIPTION OF THE PREFERRED EMBODIMENTS

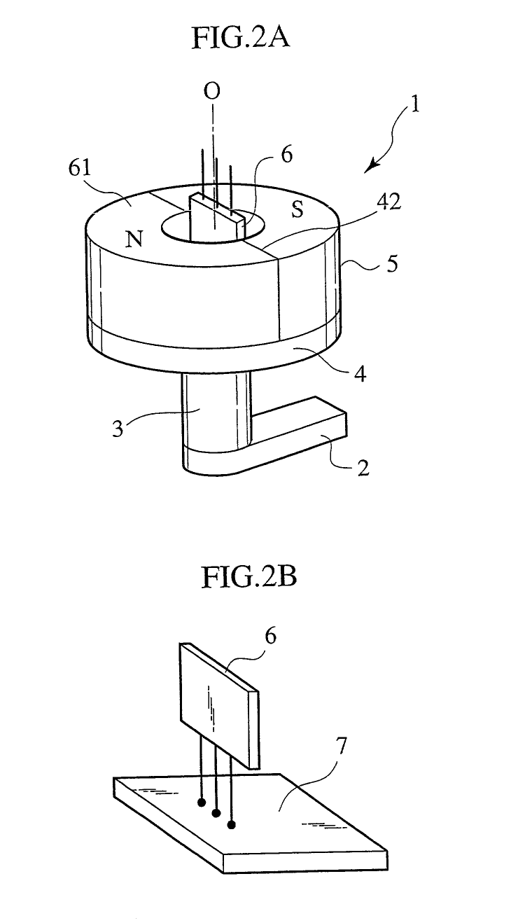

First, a structure of a rotation angle sensor of a first embodiment will be explained based on FIGS. 2A and 2B.

As shown in FIG. 2A, a rotation angle sensor 1 comprises a rotation driving pin 2 for transmitting a rotation force of a rotation apparatus to be measured, a rotation shaft 3 which is rotated by the rotation driving pin 2, a parallel magnetic field generator 5 disposed on a magnet mounting plate 4 which rotates together with the rotation shaft 3 for generating a parallel magnetic field by a magnet 61 disposed on the magnet mounting plate 4, and a Hall IC 6 for detecting the parallel magnetic field generated by the parallel magnetic field generator 5 to output voltage.

Although it is not illustrated in FIG. 2A for simplification, the Hall IC 6 is connected to a circuit substrate 7 as shown in FIG. 2B. This circuit substrate 7 is fixed to a case (not shown) of the rotation angle sensor.

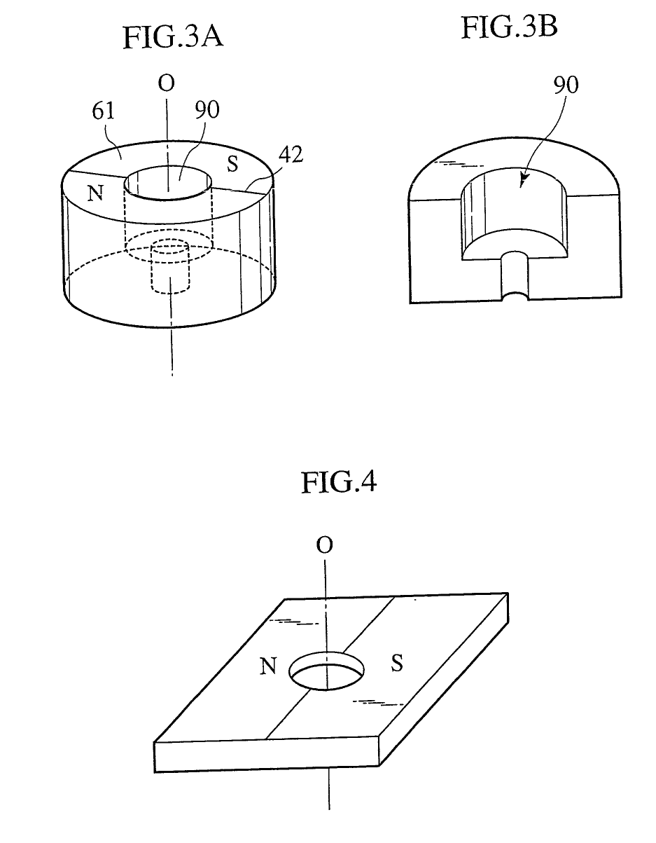

Here, the parallel magnetic field generator 5 comprises the magnet 61 formed such that its north pole and south pole are symmetric with respect to a magnetic field boundary surface 42. A portion of the magnet 61 corresponding to a periphery of a rotation center O of the rotation shaft 3 is hollowed out as shown in FIGS. 3A and 3B, thereby forming a hollowed-out portion 90. In this hollowed-out portion 90, the magnet generates a parallel magnetic field 43 in a vertical direction with respect to the rotation center O. Therefore, the parallel magnetic field generator 5 may be of cylindrical shape as shown in FIG. 3A or rectangular parallelepiped shape or other shape only if the north pole and the south pole are symmetric. Further, the hollowed-out portion 90 also may not be of cylindrical shape, and may be rectangular parallelepiped shape or other shape only if the north pole and the south pole are symmetric.

The Hall IC 6 may be disposed on any position only if the Hall IC 6 can detect the parallel magnetic field 43, but it is preferable to dispose the Hall IC 6 on the intersection between an end surface of the magnet 61 of the parallel magnetic field generator 5 and the rotation center O, because the magnetic field strength of the parallel magnetic field is strong and stable.

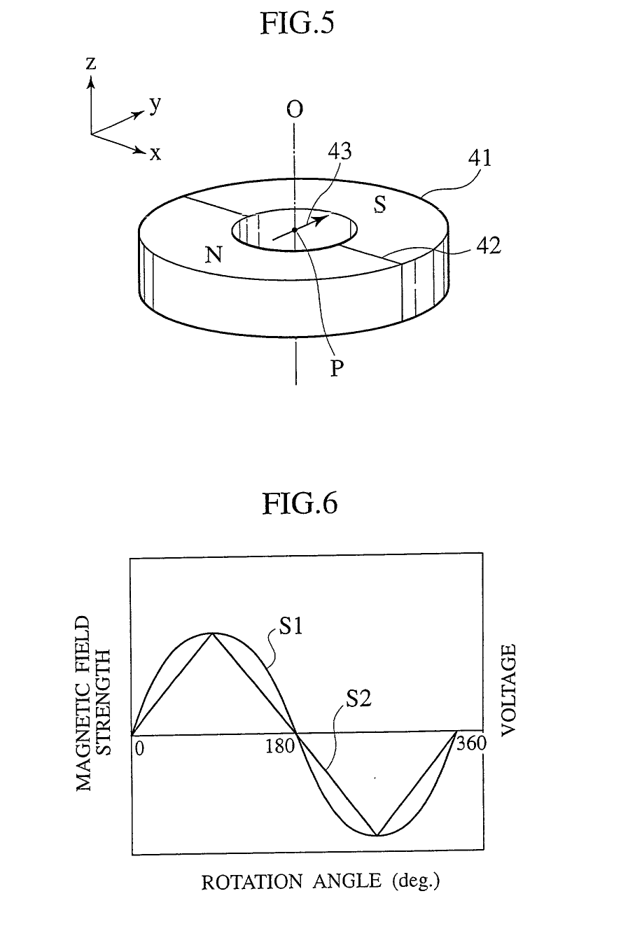

Next, a measuring principle of rotation angle of by the rotation angle sensor of this embodiment will be explained based on FIGS. 5 and 6.

In FIG. 5 showing the principle, the parallel magnetic field is obtained at the intersection P between the end surface of a magnet 41 as the parallel magnetic field generator and the rotation center O as described above. Therefore, if the magnet 41 rotates by rotation of an object to be measured, a magnetic field strength in the X direction at the intersection P is sin waveform as shown with S1 in FIG. 6.

The magnetic field strength is detected by the Hall IC 6 disposed on the intersection P, and output voltage of sin waveform which is the same as the magnetic field strength is output. Further, this output voltage is converted into voltage characteristic which is proportional to a rotation angle as shown with S2 in FIG. 6 by means of an arithmetic circuit disposed on the circuit substrate 7. In this case, since two same output voltages exist in a rotation range of 0° to 360°, the rotation angle sensor can measure a rotation angle of 180° (90° to 270° in FIG. 6) at the maximum.

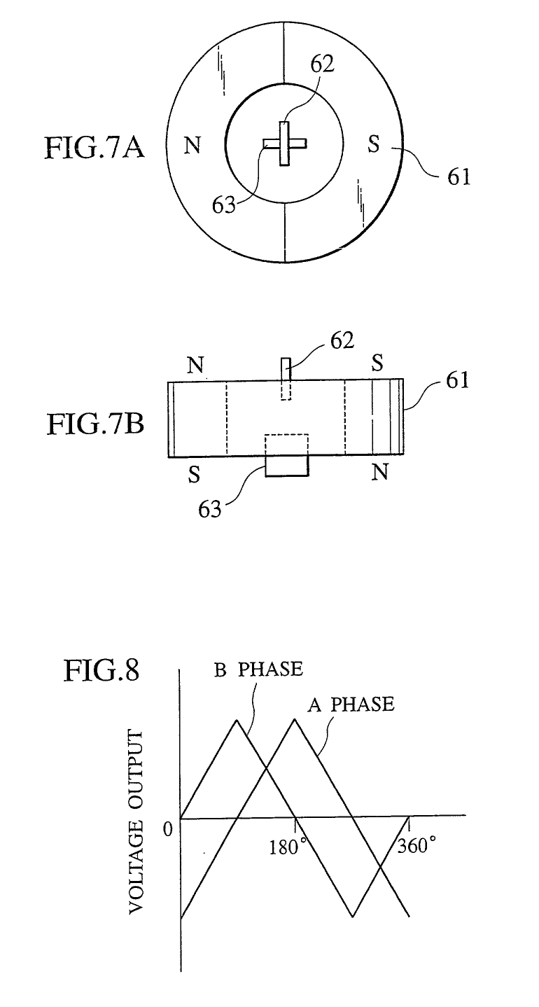

In order to allow the rotation angle sensor to measure a rotation angle of 0° to 360°, as shown in FIG. 7, a plurality of Hall ICs 62 and 63 are disposed on the rotation center O at different angle with respect to the parallel magnetic field. With this design, the rotation angle sensor can measure the rotation angle of 0° to 360°.

In FIG. 7B, the Hall IC 62 is disposed in an end surface of the upper side of the magnet 61, and the Hall IC 63 is disposed in an end surface of the lower side of the magnet 61 at a position displaced through 90° with respect to the Hall IC 62.

FIG. 8 shows output voltages of the Hall ICs 62 and 63. In FIG. 8, a value obtained by converting the output voltage of the Hall IC 62 by the circuit substrate 7 is defined as an A phase, and a value obtained by converting the output voltage of the Hall IC 63 by the circuit substrate 7 is defined as an B phase. By comparing the two voltage characteristics of the A and B phases, it is possible to measure a rotation angle of 0° to 360°.

For example, when only the output voltage of the A phase is converted into the rotation angle, the same values exist in 0° to 180° and in 180° to 360°. Therefore, when the B phase is plus potential by a value of the B phase, it is judged that the A phase is in a range of 0° to 180°, and when the B phase is minus potential, it is judged that the A phase is in a range of 180° to 360°, and with this judgement, a rotation angle in a range of 0° to 360° can be calculated.

When only the A phase is minus potential, it is judged that the A phase is in a range of 0° to 90°, the rotation angle is calculated from the output voltage of the B phase. When both the A and B phases are plus potential, it is judged that they are in a range of 90° to 180°, the rotation angle is calculated from the output voltage of the A phase. When only the B phase is minus potential, it is judged that the B phase is in a range of 180° to 270°, the rotation angle is calculated from the output voltage of the B phase. When both the A and B phases are minus potential, it is judged that they are in a range of 270° to 360°, the rotation angle is calculated from the output voltage of the A phase.

Although the range of the rotation angle is judged depending upon whether the potential is plus or minus here, it is also possible to judge the range of rotation angle by comparing a given voltage reference value and actual voltage, thereby calculating the rotation angle in the range 0° to 360°.

As described above, the rotation angle sensor of this embodiment is constituted only by the magnet and the Hall IC, and parts such as stators and tube-like yoke are not required. Therefore, the shape of the sensor is simplified, and the number of parts can be decreased, which can reduce the costs.

Further, since the stators are not used, rotation torque is not generated and thus, the sensor can be mounted to a rotation apparatus having small driving torque.

Furthermore, since the stators are not used, attraction force is not generated between the magnet and the stators, it is unnecessary to strongly fix the rotation shaft and the magnet. Since the rotation shaft need not be strong, the rotation shaft may not be made of strong material such as metal, and it can be made of resin material such as common nylon.

A rotation angle sensor of a second embodiment will be explained.

The rotation angle sensor of the second embodiment is different from that of the first embodiment in that a non-linear Hall IC is used instead of the Hall IC.

A normal Hall IC output voltage which is proportional to magnetic field strength, but the non-linear Hall IC is different from the normal Hall IC in that the non-linear Hall IC can obtain desired arbitrary output voltage with respect to the magnetic field strength.

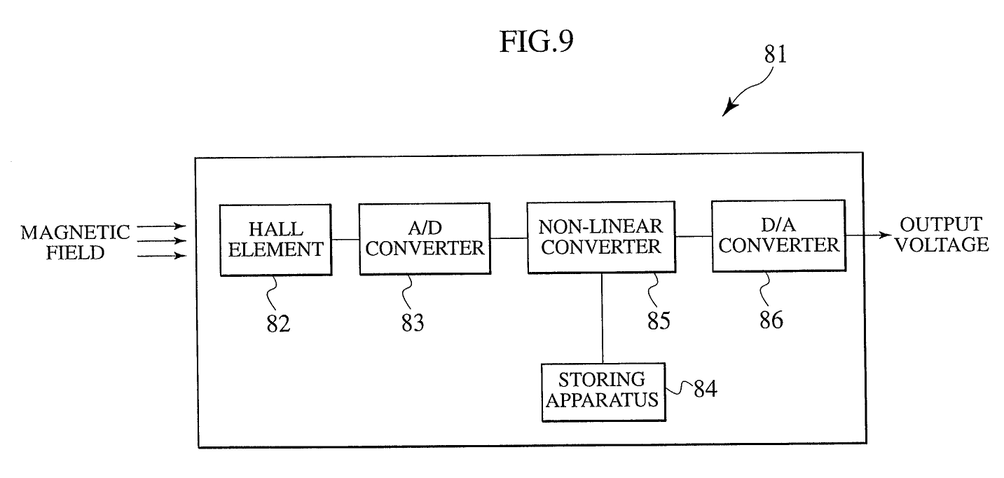

First, a structure of a non-linear Hall IC 81 will be explained based on FIG. 9.

As shown in FIG. 9, the non-linear Hall IC 81 comprises a Hall element 82 which detects magnetic field strength and outputs Hall voltage in accordance with the magnetic field strength, an A/D converter 83 for converting the Hall voltage output from the Hall element 82 from analogue value into a digital value, storing apparatus 84 for storing conversion information for converting the digital value of the Hall voltage converted by the A/D converter 83 into a non-linear value, non-linear converter 85 for converting the digital value of the Hall voltage into the non-linear value to obtain output voltage based on the conversion information stored in the storing apparatus 84, and a D/A converter 86 for converting the digital value of the output voltage converted by the non-linear converter 85 into the analogue value to output the same.

In this non-linear Hall IC 81, the non-linear converter 85 is constituted by a DSP (Digital Signal Processing), a microcomputer and the like, and the storing apparatus 84 is constituted by a memory such as EEPROM.

Next, converting processing of the Hall voltage in the non-linear Hall IC 81 will be explained.

First, the Hall element 82 detects magnetic field, and outputs Hall voltage in accordance with the magnetic field. Then, the A/D converter 83 converts the Hall voltage from the analogue value to the digital value.

Then, the non-linear converter 85 converts the Hall voltage into non-linear output voltage based on the conversion information stored in the storing apparatus 84.

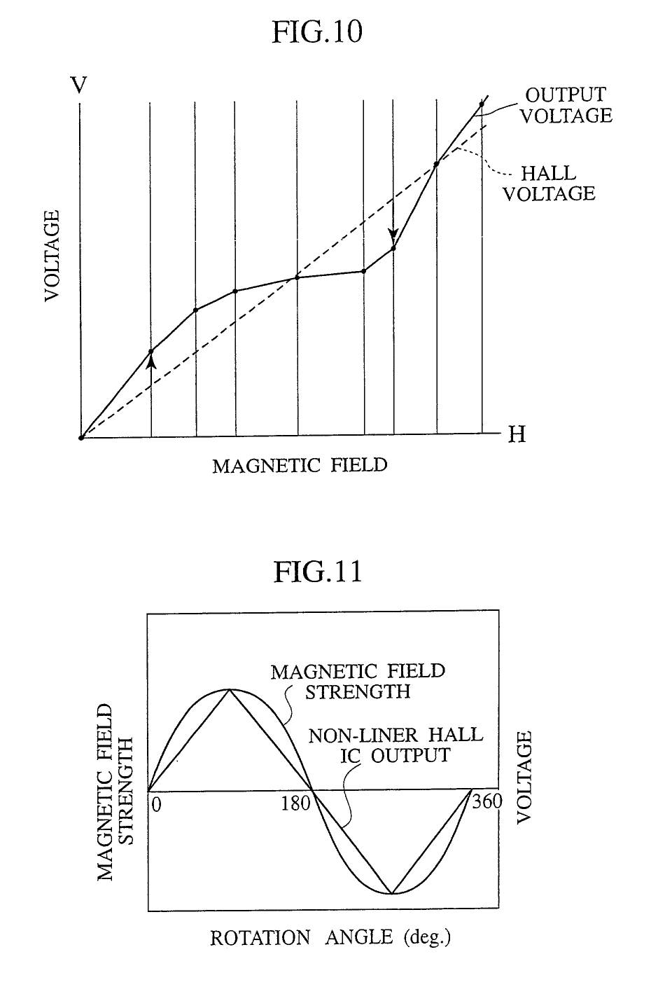

As shown in FIG. 10 for example, the magnetic field strength is divided into arbitrary sections, and the Hall voltage shown with a dotted line in each section is converted into output voltage shown with a solid line. In each section in FIG. 10, the sections are interpolated with separate straight lines.

In this case, the magnetic field strength is divided into arbitrary sections, and in each section, the following equation is set:

H=a×Vh (1)

(Vh: Hall voltage, H: magnetic field strength, a: arbitrary constant)

and this equation is stored in the storing apparatus 84. If Hall voltage is input into the non-linear converter 85, a magnetic field strength is calculated based on the equation (1) from this Hall voltage, and it is judged which section.

In each section, the following equation is set:

V=b×Vh+c (2)

(V: output voltage, b, c: arbitrary constants)

and this equation is stored in the storing apparatus 84. Based on this equation (2), output voltage V is calculated from the Hall voltage Vh. In this manner, linear Hall voltage output by the Hall element 82 is converted by the equation set in each section. With this operation, non-linear output voltage shown in FIG. 10 can be output.

Although the magnetic field strength is divided at arbitrary distances in FIG. 10, the magnetic field strength may be divided by equal distances, or the Hall voltage may be converted into output voltage shown with tertiary curve or other curve.

The Hall voltage is converted into the non-linear output voltage by the non-linear converter 85 in this manner, and the output voltage is converted from digital value into the analogue value by the D/A converter 86, and output voltage of the analogue value is output.

The non-linear Hall IC 81 can convert the Hall voltage into non-linear output voltage and obtain arbitrary output voltage required for the magnetic field strength.

If such a non-linear Hall IC is used instead of Hall IC 6 shown in FIG. 2A, when then on-linear Hall IC detects sin wave form magnetic field strength shown in FIG. 11, the magnetic field strength is converted into output voltage which is proportional to the rotation angle and is output.

Therefore, it is unnecessary to convert the output voltage of the Hall IC 6 into the output voltage which is proportional to the rotation angle in the circuit substrate 7, unlike the first embodiment, the circuit substrate 7 can be simplified, the sensor can be made compact as compared with the first embodiment, and it is possible to realize cost-down.

Also when the rotation angle of 0° to 360°, if a plurality of Hall ICs 62, 63 shown in FIG. 7A are respectively replaced by non-linear Hall ICs, it is possible to realize a rotation angle sensor capable of measuring the rotation angle of 0° to 360°.

In this case also, since the magnetic field strength is converted into output voltage which is proportional to rotation angle and is output by the non-linear Hall IC, it is possible to further reduce the sensor in size and to realize the cost-down as compared with the first embodiment.

What is claimed is:

1. A rotation angle sensor for measuring a rotation angle of an object to be measured, comprising
a rotation shaft which is rotated by rotation of said object to be measured,
a parallel magnetic field generator generating parallel magnetic field which is rotated as said rotation shaft rotates,
magnetic force detector detecting magnetic field strength in said parallel magnetic field generated by said parallel magnetic field generator, and for outputting output voltage based on said magnetic field strength, and
rotation angle calculator calculating a rotation angle of said object to be measured based on said output voltage output from said magnetic force detector.

2. A rotation angle sensor according to claim 1, wherein
the number of said magnetic force detector is two or more, and the plurality of magnetic force detector is disposed at different angles with respect to said parallel magnetic field, said rotation angle calculator calculates a rotation angle of said object to be measured based on output voltage output respective magnetic force detector.

3. A rotation angle sensor for measuring a rotation angle of an object to be measured, comprising
a rotation shaft which is rotated by rotation of said object to be measured,
a parallel magnetic field generator for generating parallel magnetic field which is rotated as said rotation shaft rotates,
magnetic force converter for detecting magnetic field strength in said parallel magnetic field generated by said parallel magnetic field generator, and converting this magnetic field strength into output voltage indicative of a rotation angle of said object to he measured.

4. A rotation angle sensor according to claim 3, wherein
the number of said magnetic force detector is two or more, and the plurality of magnetic force detector is disposed at different angles with respect to said parallel magnetic field, said rotation angle sensor further comprises rotation angle calculator calculating a rotation angle of said object to be measured based on output voltage output respective magnetic force detector.

5. A rotation angle sensor according to claim 1, wherein
said magnetic force detector comprises a Hall element, said Hall element can detect a rotation angle of said object to be measured in a range of 0° to 180°.

6. A rotation angle sensor according to claim 3, wherein
said magnetic force converter comprises a non-linear Hall IC, said Hall IC can detect a rotation angle of said object to be measured in a range of 0° to 180°.

7. A rotation angle sensor according to claim 2, wherein
said magnetic force detector comprises at least two Hall elements disposed at different angle with respect to said parallel magnetic field, each of said Hall elements can detect a rotation angle of said object to be measured in a range of 0° to 360°.

8. A rotation angle sensor according to claim 4, wherein
said magnetic force converter comprises at least two non-linear Hall ICs disposed at different angle with respect to said parallel magnetic field, each of said Hall ICs can detect a rotation angle of said object to be measured in a range of 0° to 360°.

9. A rotation angle sensor according to claim 1, wherein
said parallel magnetic field generator comprises
a magnet having north pole and south pole which are symmetric in shape with respect to a magnetic field boundary, and
a hollow-out portion formed by hollowing an intersection between the magnetic field strength boundary on said magnet and a rotation center of said rotation shaft,
the parallel magnetic field is generated in said hollow-out portion.

10. A rotation angle sensor according to claim 9, wherein
at least one of said magnetic force detector is disposed in said hollow-out portion.

11. A rotation angle sensor according to claim 3, wherein
said parallel magnetic field generator comprises
a magnet having north pole and south pole which are symmetric in shape with respect to a magnetic field boundary, and
a hollow-out portion formed by hollowing an intersection between the magnetic field strength boundary on said magnet and a rotation center of said rotation shaft,
the parallel magnetic field is generated in said hollow-out portion.

12. A rotation angle sensor according to claim 11, wherein
at least one of said magnetic force converter
is disposed in said hollow-out portion.
